(19) United States
(12) Patent Application Publication
(10) Pub. No.: US 2023/0217336 A1
(43) Pub. Date: Jul. 6, 2023

(54) ELECTRONIC DEVICE FOR PERFORMING HANDOVER ON BASIS OF STATE OF ELECTRONIC DEVICE, AND OPERATION METHOD OF ELECTRONIC DEVICE

(71) Applicant: SAMSUNG ELECTRONICS CO., LTD., Suwon-si (KR)

(72) Inventors: Sangwon KIM, Suwon-si (KR); Jaehyun SIM, Suwon-si (KR)

(21) Appl. No.: 18/118,171

(22) Filed: Mar. 7, 2023

Related U.S. Application Data
(63) Continuation of application No. PCT/KR2021/012238, filed on Sep. 8, 2021.

(30) Foreign Application Priority Data
Sep. 8, 2020 (KR) 10-2020-0114782

(51) Int. Cl. H04W 36/24

(52) U.S. Cl. CPC H04W 36/24

(57) ABSTRACT

An example electronic device includes a communication processor for establishing a cellular communication with a first node supporting a first frequency band or a second node supporting a second frequency band; an application processor; and memory. The memory can store instructions which, when executed, control the communication processor such that: the communication processor confirms a service type performed by the cellular communication; the application processor confirms whether or not the state of the electronic device satisfies a predetermined condition set differently in accordance with the service type; and the application processor blocks a connection with the second node and/or releases the connection with the second node, in response to confirming that the state of the electronic device does not satisfy the predetermined condition.

### CROSS-REFERENCE TO RELATED APPLICATIONS

This application is a continuation of International Application No. PCT/KR2021/012238, designating the United States, filed on Sep. 8, 2021, in the Korean Intellectual Property Receiving Office and claiming priority to Korean Patent Application No. 10-2020-0114782, filed on Sep. 8, 2020 in the Korean Intellectual Property Office. The disclosures of each of these applications are incorporated by reference herein in their entireties.

### FIELD

The disclosure relates to an electronic device and an operation method of the electronic device and, more particularly, to technology that performs handover based on a state of the electronic device.

### DESCRIPTION OF RELATED ART

In order to meet wireless data traffic demands that have increased after commercialization of 4th Generation (4G) communication system, efforts to develop an improved 4th Generation (5G) communication system or a pre-5G communication system have been made. For this reason, the 5G communication system or the pre-5G communication system is called a beyond 4G network communication system or a post LTE system. In order to achieve a high data transmission rate, an implementation of the 5G communication system in a mmWave band (for example, 60 GHz band) is being considered. In the 5G communication system, technologies such as beamforming, massive MIMO, Full Dimensional MIMO (FD-MIMO), array antenna, analog beam-forming, and large scale antenna are being discussed.

### SUMMARY

A frequency band supported by an electronic device may include frequency range 1 (FR1) that is a frequency band of 6 GHz or less and FR2 that is a frequency band of 6 GHz or more. When compared to a signal of FR1, a signal of FR2 may have high straightness, and thus path loss and loss caused by reflection by an external object may be high. Therefore, the power consumption of the electronic device that performs communication using an FR2 signal may be increased when compared to the case that the electronic device performs communication using a signal of the FR1.

In a cellular network system, handover, an operation of changing a base station connected to an electronic device, may be embodied according to control by a network. Based on the state (e.g., a resource allocation state) of the network, the cellular network system may determine whether to perform handover of an electronic device.

In this instance, the cellular network system may not perform handover in consideration of the state of the electronic device. In a situation in which, due to various reasons (e.g., when the residual quantity of a battery of an electronic device is insufficient), the electronic device needs to minimize connection to a base station that supports an FR2 signal, the electronic device may be connected to the base station that supports an FR2 signal. When the electronic device is connected to the base station that supports the FR2 signal, the amount of power unnecessarily consumed may be increased.

An electronic device according to various embodiments of the disclosure may include a communication processor configured to perform cellular communication with a first node supporting a first frequency band or a second node supporting a second frequency band, an application processor, and a memory, wherein the memory may store instructions which, when executed, cause the electronic device to identify a type of service performed via the cellular communication, identify whether a state of the electronic device satisfies a designated condition configured differently based on the type of service, and, in response to identifying that the state of the electronic device does not satisfy the designated condition, perform at least one operation that prevents connection to the second node or releases connection from the second node.

An operation method of an electronic device according to various embodiments of the disclosure may include identifying a type of service performed via cellular communication, identifying whether a state of the electronic device satisfies a designated condition configured differently based on the type of service, and performing at least one operation of preventing connection to the second node or releasing connection from the second node based on whether the state of the electronic device satisfies the designated condition.

An electronic device and an operation method of an electronic device according to various embodiments of the disclosure may release or prevent, based on a state of the electronic device, connection to a node that supports a relatively high frequency band, and thus may reduce unnecessary power consumption.

An electronic device and an operation method of an electronic device according to various embodiments of the disclosure may release or prevent connection to a node that supports a relatively high frequency band using a designated condition configured differently based on the type of service performed via cellular communication. Therefore, an electronic device and an operation method of an electronic device may, based on the type of service performed via cellular communication, selectively connect to a node that supports a relatively high frequency band, and thus may reduce power consumption.

### BRIEF DESCRIPTION OF THE DRAWINGS

The above and/or other aspects of the disclosure will be more apparent by describing certain embodiments of the disclosure with reference to the accompanying drawings, in which:

FIG. 1 is a block diagram of an example electronic device according to various embodiments;

FIG. 2 is a block diagram of an example electronic device for supporting legacy network communication and 5G network communication according to various embodiments;

FIG. 3 is a diagram illustrating a protocol stack structure of a network 100 of legacy communication and/or 5G communication according to various embodiments;

FIG. 4 is a diagram illustrating wireless communication systems that provide a network of legacy communication and/or the 5G communication according to various embodiments;

FIG. 5 is a block diagram of an example electronic device according to various embodiments of the disclosure;

FIG. 6 is a diagram illustrating an embodiment in which an example electronic device according to various embodiments of the disclosure determines whether to perform handover based on whether a state of the electronic device satisfies a designated condition;

FIG. 7 is a diagram illustrating an embodiment in which an example electronic device according to various embodiments of the disclosure determines whether to perform handover based on whether a state of the electronic device satisfies a designated condition;

FIG. 8 is a diagram illustrating an embodiment in which an example electronic device according to various embodiments of the disclosure determines whether to perform handover based on whether a state of the electronic device satisfies a designated condition;

FIG. 9 is a diagram illustrating an embodiment in which an example electronic device according to various embodiments of the disclosure performs connection to a first node based on whether a state of the electronic device satisfies a designated condition; and

FIG. 10 is a flowchart illustrating an example operation method of an example electronic device according to various embodiments.

### DETAILED DESCRIPTION

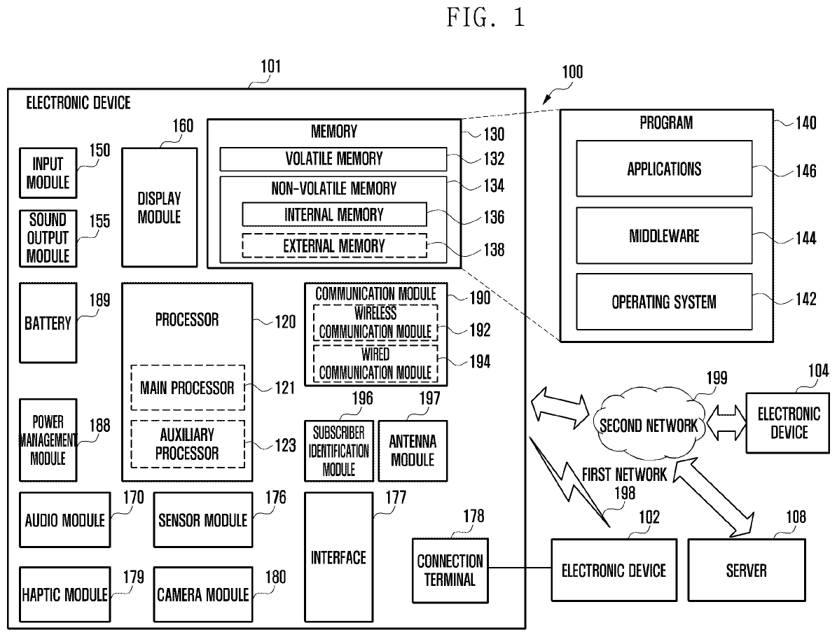

FIG. 1 is a block diagram illustrating an example electronic device 101 in a network environment 100 according to certain embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a connection terminal 178, a haptic module 179, a camera module 180, a power management module 188, a battery 189, a communication module 190, a subscriber identification module (SIM) 196, or an antenna module 197. In various embodiments, at least one (e.g., the display device 160 or the camera module 180) of the components may be omitted from the electronic device 101, or one or more other components may be added to the electronic device 101. In various embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of, the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of, the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connection terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of or including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

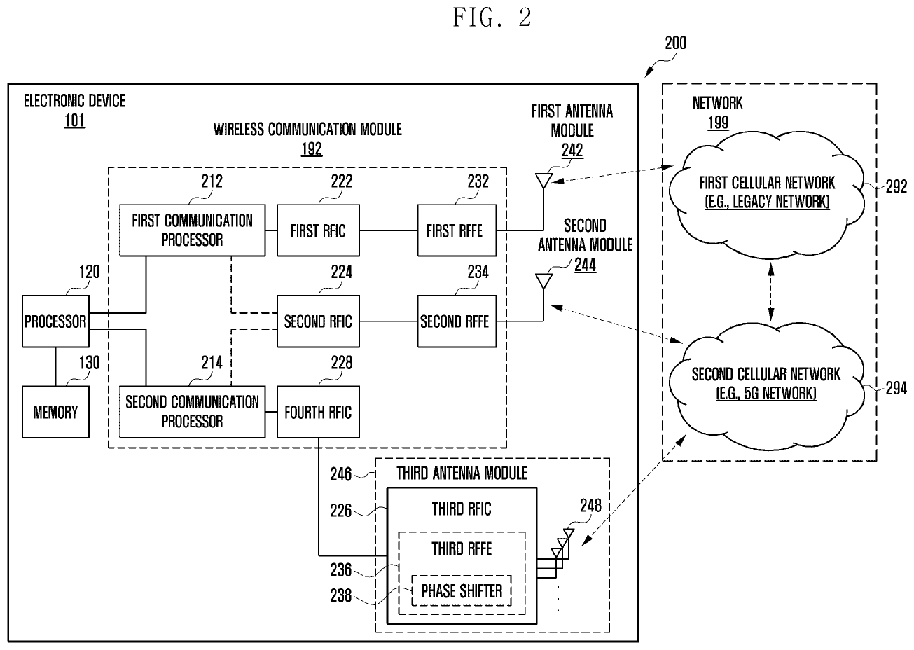

FIG. 2 is a block diagram 200 of an example electronic device 101 for supporting legacy network communication and 5G network communication according to various embodiments. Referring to FIG. 2, the electronic device 101 may include a first communication processor 212, a second communication processor 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, and an antenna 248. The electronic device 101 may further include the processor 120 and the memory 130. The network 199 may include a first network 292 and a second network 294. According to an embodiment, the electronic device 101 may further include at least one component among the components illustrated in FIG. 1, and the network 199 may further include at least one other network. According to an embodiment, the first communication processor 212, the second communication processor 214, the first RFIC 222, the second RFIC 224, the fourth RFIC 228, the first RFFE 232, and the second RFFE 234 may be included as at least a part of the wireless communication module 192. According to an embodiment, the fourth RFIC 228 may be omitted or may be included as a part of the third RFIC 226.

The first communication processor 212 may establish a communication channel of a band to be used for wireless communication with the first network 292, and may support legacy network communication via the established communication channel According to certain embodiments, the first network may be a legacy network including 2G, 3G, 4G, or long term evolution (LTE) network. The second communication processor 214 may establish a communication channel corresponding to a designated band (e.g., approximately 6 GHz to 60 GHz) among bands to be used for wireless communication with the second network 294, and may support 5G network communication via the established channel According to various embodiments, the second network 294 may be a 5G network defined in 3GPP. Additionally, according to an embodiment, the first communication processor 212 or the second communication processor 214 may establish a communication channel corresponding to another designated band (e.g., lower than 6 GHz) among bands to be used for wireless communication with the second network 294, and may support 5G network communication via the established channel According to an embodiment, the first communication processor 212 and the second communication processor 214 may be implemented in a single chip or a single package. According to variou embodiments, the first communication processor 212 or the second communication processor 214 may be implemented in a single chip or a single package, together with the processor 120, the sub-processor 123, or the communication module 190.

In the case of transmission, the first RFIC 222 may convert a baseband signal generated by the first communication processor 212 into a radio frequency (RF) signal in a range of approximately 700 MHz to 3 GHz used for the first network 292 (e.g., a legacy network). In the case of reception, an RF signal is obtained from the first network 292 (e.g., a legacy network) via an antenna (e.g., the first antenna module 242), and may be preprocessed via an RFFE (e.g., the first RFFE 232). The first RFIC 222 may convert the preprocessed RF signal to a baseband signal so that the base band signal is processed by the first communication processor 212.

In the case of transmission, the second RFIC 224 may convert a baseband signal generated by the first communication processor 212 or the second communication processor 214 into an RF signal (hereinafter, a 5G Sub6 RF signal) of a Sub6 band (e.g., lower than 6 GHz) used for the second network 294 (e.g., 5G network). In the case of reception, a 5G Sub6 RF signal is obtained from the second network 294 (e.g., a 5G network) via an antenna (e.g., the second antenna module 244), and may preprocessed by an RFFE (e.g., the second RFFE, 234). The second RFIC 224 may convert the preprocessed 5G Sub6 RF signal into a baseband signal so that the baseband signal is processed by a corresponding communication processor from among the first communication processor 212 or the second communication processor 214.

The third RFIC 226 may convert a baseband signal generated by the second communication processor 214 into an RF signal (hereinafter, a 5G Above6 RF signal) of a 5G Above6 band (e.g., approximately 6 GHz to 60 GHz) to be used for the second network 294 (e.g., 5G network). In the case of reception, a 5G Above6 RF signal is obtained from the second network 294 (e.g., a 5G network) via an antenna (e.g., the antenna 248), and may be preprocessed by the third RFFE 236. The third RFIC 226 may convert the preprocessed 5G Above6 RF signal to a baseband signal so that the base band signal is processed by the second communication processor 214. According to an embodiment, the third RFFE 236 may be implemented as a part of the third RFIC 226.

According to an embodiment, the electronic device 101 may include the fourth RFIC 228, separately from or as a part of the third RFIC 226. In this instance, the fourth RFIC 228 may convert a baseband signal generated by the second communication processor 214 into an RF signal (hereinafter, an IF signal) in an intermediate frequency band (e.g., approximately 9 GHz to 11 GHz), and may transfer the IF signal to the third RFIC 226. The third RFIC 226 may convert the IF signal to a 5G Above6 RF signal. In the case of reception, a 5G Above6 RF signal is received from the second network 294 (e.g., a 5G network) via an antenna (e.g., the antenna 248), and may be converted into an IF signal by the third RFFE 226. The fourth RFIC 228 may convert the IF signal to a baseband signal so that the base band signal is processed by the second communication processor 214.

According to an embodiment, the first RFIC 222 and the second RFIC 224 may be implemented as a single chip or at least a part of a single package. According to an embodiment, the first RFFE 232 and the second RFFE 234 may be implemented as a single chip or at least a part of a single package. According to an embodiment, at least one antenna module of the first antenna module 242 or the second antenna module 244 may be omitted, or may be combined with another antenna module so as to process RF signals in a plurality of bands.

According to an embodiment, the third RFIC 226 and the antenna 248 may be disposed in the same substrate, and may form the third antenna module 246. For example, the wireless communication module 192 or the processor 120 may be disposed in a first substrate (e.g., main PCB). In this instance, the third RFIC 226 is disposed in a part (e.g., a lower part) of the second substrate (e.g., a sub PCB) separate from the first substrate and the antenna 248 is disposed on another part (e.g., an upper part), so that the third antenna module 246 is formed. By disposing the third RFIC 226 and the antenna 248 in the same substrate, the length of a transmission line therebetween may be reduced. For example, this may reduce a loss (e.g., attenuation) of a signal in a high-frequency band (e.g., approximate 6 GHz to 60 GHz) used for 5G network communication, the loss being caused by a transmission line. Accordingly, the electronic device 101 may improve the quality or speed of communication with the second network 294 (e.g., 5G network).

According to an embodiment, the antenna 248 may be implemented as an antenna array including a plurality of antenna elements which may be used for beamforming. In this instance, the third RFIC 226 may be, for example, a part of the third RFFE 236, and may include a plurality of phase shifters 238 corresponding to a plurality of antenna elements. In the case of transmission, each of the plurality of phase shifters 238 may shift the phase of a SG Above6RF signal to be transmitted to the outside of the electronic device 101 (e.g., a base station of a SG network) via a corresponding antenna element. In the case of reception, each of the plurality of phase shifters 238 may shift the phase of the SG Above6 RF signal received from the outside via a corresponding antenna element into the same or substantially the same phase. This may enable transmission or reception via beamforming between the electronic device 101 and the outside.

The second network 294 (e.g., SG network) may operate independently (e.g., Stand-Along (SA)) from the first network 292 (e.g., a legacy network), or may operate by being connected thereto (e.g., Non-Stand Alone (NSA)). For example, in the SG network, only an access network (e.g., SG radio access network (RAN) or next generation RAN (NG RAN)) may exist, and a core network (e.g., next generation core (NGC)) may not exist. In this instance, the electronic device 101 may access an access network of the 5G network, and may access an external network (e.g., the Internet) under the control of the core network (e.g., an evolved packed core (EPC)) of the legacy network. Protocol information (e.g., LTE protocol information) for communication with the legacy network or protocol information (e.g., New Radio (NR) protocol information) for communication with the 5G network may be stored in the memory 230, and may be accessed by another component (e.g., the processor 120, the first communication processor 212, or the second communication processor 214).

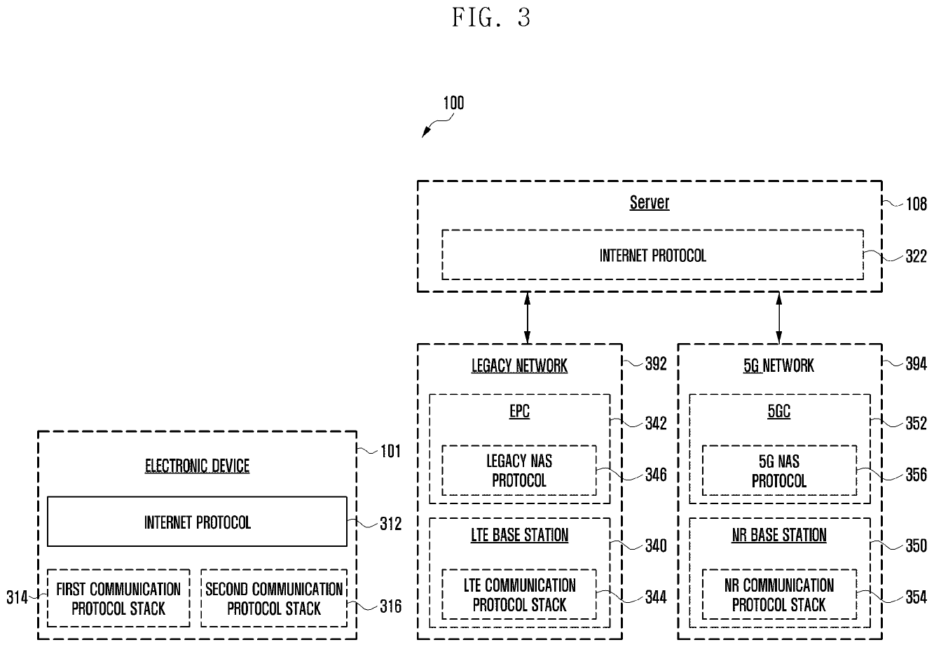

FIG. 3 illustrates a protocol stack structure of the network 100 of legacy communication and/or 5G communication according to an embodiment.

Referring to FIG. 3, the network 100 according to an illustrated embodiment may include the electronic device 101, a legacy network 392, a 5G network 394, and the server 108.

The electronic device 101 may include an Internet protocol 312, a first communication protocol stack 314, and a second communication protocol stack 316.

The electronic device 101 may communicate with the server 108 through the legacy network 392 and/or the 5G network 394.

According to an embodiment, the electronic device 101 may perform Internet communication associated with the server 108 through the Internet protocol 312 (for example, a TCP, a UDP, or an IP). The Internet protocol 312 may be executed by, for example, a main processor (for example, the main processor 121 of FIG. 1) included in the electronic device 101.

According to an embodiment, the electronic device 101 may perform wireless communication with the legacy network 392 through the first communication protocol stack 314. According to an embodiment, the electronic device 101 may perform wireless communication with the 5G network 394 through the second communication protocol stack 316. The first communication protocol stack 314 and the second communication protocol stack 316 may be executed by, for example, one or more communication processors (for example, the wireless communication module 192 of FIG. 1) included in the electronic device 101.

The server 108 may include an Internet protocol 322. The server 108 may transmit and receive data related to the Internet protocol 322 to and from the electronic device 101 through the legacy network 392 and/or the 5G network 394. According to an embodiment, the server 108 may include a cloud computing server existing outside the legacy network 392 or the 5G network 394. According to an embodiment, the server 108 may include an edge computing server (or a mobile edge computing (MEC) server) located inside at least one of the legacy network or the 5G network 394.

The legacy network 392 may include an LTE eNode B (eNB) 340 and an EPC 342. The LTE eNB 340 may include an LTE communication protocol stack 344. The EPC 342 may include a legacy NAS protocol 346. The legacy network 392 may perform LTE wireless communication with the electronic device 101 through the LTE communication protocol stack 344 and the legacy NAS protocol 346.

The 5G network 394 may include an NR gNB 350 and a 5GC 352. The NR gNB 350 may include an NR communication protocol stack 354. The 5GC 352 may include a 5G NAS protocol 356. The 5G network 394 may perform NR wireless communication with the electronic device 101 through the NR communication protocol stack 354 and the 5G NAS protocol 356.

According to an embodiment, the first communication protocol stack 314, the second communication protocol stack 316, the LTE communication protocol stack 344, and the NR communication protocol stack 354 may include a control plane protocol for transmitting and receiving a control message and a user plane protocol for transmitting and receiving user data. The control message may include a message related to at least one of, for example, security control, bearer setup, authentication, registration, or mobility management. The user data may include, for example, the remaining data except other than the control message.

According to an embodiment, the control plane protocol and the user plane protocol may include a physical (PHY) layer, a medium access control (MAC) layer, a radio link control (RLC) layer, or a packet data convergence protocol (PDCP) layer. The PHY layer may channel-code and modulate data received from, for example, a higher layer (for example, the MAC layer), transmit the data through a radio channel, demodulate and decode the data received through the radio channel, and transmit the data to the higher layer. The PHY layer included in the second communication protocol stack 316 and the NR communication protocol stack 354 may further perform an operation related to beamforming. The MAC layer may logically/physically map, for example, data to a radio channel for transmitting and receiving the data and perform a hybrid automatic repeat request (HARQ) for error correction. The RLC layer may perform, for example, data concatenation, segmentation, or reassembly, and data sequence identification, reordering, or duplication detection. The PDCP layer may perform an operation related to, for example, ciphering of a control message and user data and data integrity. The second communication protocol stack 316 and the NR communication protocol stack 354 may further include a service data adaptation protocol (SDAP). The SDAP may manage allocation of radio bearers on the basis of quality of service (QoS) of user data.

According to various embodiments, the control plane protocol may include a radio resource control (RRC) layer and a non-access stratum (NAS) layer. The RRC layer may process control, for example, data related to radio bearer setup, paging, or mobility management. The NAS may process, for example, a control message related to authentication, registration, or mobility management.

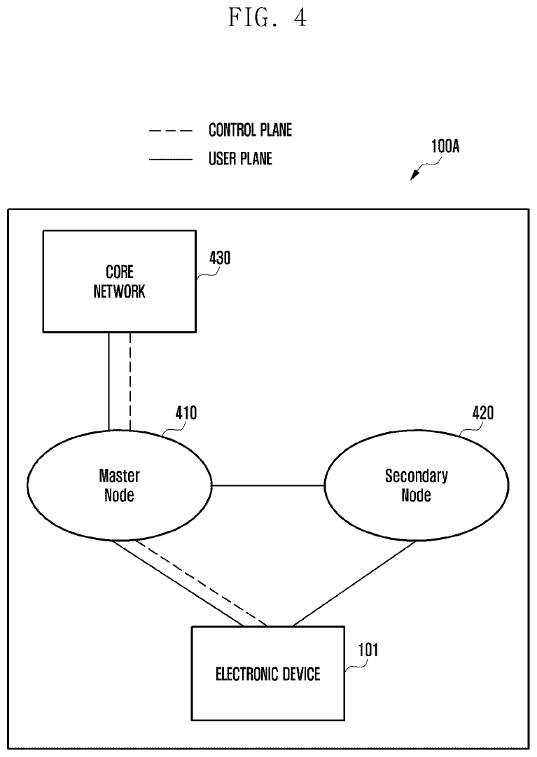

FIG. 4 is a diagram illustrating wireless communication systems that provide a network of cellular communication according to various embodiments.

Referring to FIG. 4, a network environment 100A may include a cellular communication network. The cellular communication network may include a new radio (NR) base station (e.g., a gNodeB (gNB)) that supports radio access to the electronic device 101 and a core network 430 (e.g., a 5^{th} generation core (5GC)) that manages 5G communication of the electronic device 101. As another example, the cellular communication network may include a 3GPP standard-based 4G or LTE base station (e.g., eNodeB (eNB)) that supports radio access to the electronic device 101, and the core network 430 (e.g., an evolved packet core (EPC)) that manages 4G communication.

According to various embodiments, the electronic device 101 may transmit or receive a control message and user data via cellular communication. The control message, for example, may include a message related to at least one of security control, bearer setup, authentication, registration, or mobility management in association with the electronic device 101. The user data, for example, may be user data, excluding a control message transmitted or received between the electronic device 101 and the core network 430.

Referring to FIG. 4, the electronic device 101 according to an embodiment may transmit or receive at least one of a control message or user data using at least a part of the network of the cellular communication (e.g., a master node 410, a secondary node 420, and the core network 430).

According to various embodiments, in an MR-DC environment, at least one of a plurality of base stations 410 and 420 may operate as the master node 410, and the other may operate as the secondary node 420. The master node 410 may be connected to the core network 430 and may transmit or receive a control message. The master node 410 and the secondary node 420 are connected via a network interface and may perform transmission or reception of a message related to radio resource management (e.g., a communication channel) therebetween.

According to various embodiments, the master node 410 and the secondary node 420 may be entities that perform communication using signals in different frequency bands. According to an embodiment, the master node 410 may be a base station that transmits or receives a signal of a first frequency band. The secondary node 420 may be a base station that transmits or receives a signal of a second frequency band.

According to various embodiments of the disclosure, the first frequency band may be a frequency band lower than the second frequency band. For example, the first frequency band may be a signal of a 6 GHz or less (e.g., frequency range 1 (FR1)) and the second frequency band may be a signal of 6 GHz or more (e.g., FR2). A signal of the second frequency band may have higher straightness than that of a signal of the first frequency band, and thus path loss and loss caused by an external object may be high. Therefore, cellular communication using the second frequency band may require power higher than cellular communication using the first frequency band. The second frequency band is a frequency band that is relatively higher than the first frequency band. The cellular communication that uses the second frequency band may use a bandwidth wider than that of cellular communication that uses the first frequency band, and thus high-speed data transmission may be enabled.

According to various embodiments of the disclosure, the core network 430 (or a cellular communication network) may perform handover of the electronic device 101 based on an environment (e.g., a network resource) of a cellular communication network. For example, the core network 430 may enable the electronic device 101 to be connected to the secondary node 420 in the state in which the electronic device 101 is connected to the master node 410. However, although it is appropriate that the electronic device 101 is connected to the master node 410, as opposed to the secondary node 420, according to the state of the electronic device 101, the core network 430 may perform handover of the electronic device 101, and thus the amount of power consumed by the electronic device 101 may be increased.

According to various embodiments of the disclosure, the core network 430 (or a cellular communication network) may perform dual connectivity of the electronic device 101 based on an environment (e.g., a network resource) of a cellular communication network. For example, the core network 430 may enable the electronic device 101 to be additionally connected to the secondary node 420 in the state in which the electronic device 101 is connected to the master node 410. However, although it is appropriate that the electronic device 101 is connected to only the master node 410 according to the state of the electronic device 101, the core network 430 may additionally connect the electronic device 101 to the secondary node 420, and thus the amount of power consumed by the electronic device 101 may be increased.

Hereinafter, a detailed embodiment that performs handover in consideration of the state of the electronic device 101 will be described in detail.

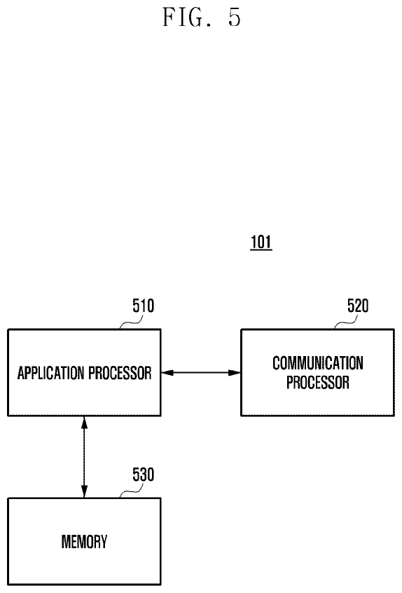

FIG. 5 is a block diagram of an electronic device according to various embodiments of the disclosure.

Referring to FIG. 5, an electronic device (e.g., the electronic device 101 of FIG. 1) according to various embodiments of the disclosure may include an application processor (AP) 510 (e.g., the processor 120 of FIG. 1), a communication processor (CP) 520 (e.g., the communication module 190 of FIG. 1 or the second communication processor 214 of FIG. 2), and/or a memory 530 (e.g., the memory 130 of FIG. 1).

According to various embodiments of the disclosure, the application processor 510 may process data that the communication processor 520 receives from a first node (e.g., the master node 410 of FIG. 4) and/or a second node (e.g., the secondary node 420 of FIG. 4). The application processor 510 may control various applications installed in the electronic device 101 using data transmitted or received.

According to various embodiments of the disclosure, the communication processor 520 may perform cellular communication with the first node 410 and/or the second node 420. The communication processor 520 may transmit user data received from the application processor 510 to the first node 410 and/or the second node 420 via cellular communication, and may transmit user data received from the first node 410 and/or the second node 420 to the application processor 510. The cellular communication may be any one of the various cellular communication schemes that the electronic device 101 is capable of supporting. For example, the cellular communication may be any one of the 5G mobile communication schemes (e.g., 5G).

According to various embodiments of the disclosure, cellular communication via the first node 410 may be cellular communication using a first frequency band (e.g., FR1), and cellular communication via the second node 420 may be cellular communication using a second frequency band (e.g., FR2).

According to various embodiments of the disclosure, the memory 530 may transitorily or non-transitorily store instructions for operation of the application processor 510 and/or the communication processor 520.

According to various embodiments of the disclosure, the application processor 510 may identify a state of the electronic device 101 and may perform, based on state information of the electronic device 101, at least one operation that prevents connection to the second node 420 or releases connection from the second node 420. For example, if the electronic device 101 is in a state that does not need to connect to the second node 420, the application processor 510 may perform at least one operation that prevents connection to the second node 420 or releases connection from the second node 420. Hereinafter, a detailed embodiment that prevents connection to the second node 420 or releases connection from the second node 420 will be described.

According to various embodiments of the disclosure, the application processor 510 may identify the type of service performed via cellular communication. The electronic device 101 may perform data communication using various services provided via a cellular communication network. According to an embodiment, a core network of the cellular communication network (e.g., the core network 430 of FIG. 4) may support network slicing. Network slicing is technology that divides a physical network into a plurality of virtual networks and provides various virtual networks according to the feature of a service (e.g., QoS). In a case that the core network 430 supports network slicing, the core network 430 may provide a virtual network resource and service which has a quality corresponding to a service that the electronic device 101 uses. For example, the core network 430 may provide a network resource and service which is embodied to have low latency in response to identifying that the service that the electronic device 101 uses is a service having low latency (e.g., vehicle to everything (V2X) or ultra-reliable and low latency communication (URLLC)). As another example, the core network 430 may provide a network resource and service embodied to achieve a fast transmission time in response to identifying that the service that the electronic device 101 uses is a service that requires a fast transmission time (e.g., enhanced mobile broadband (eMBB)). Each of the various services that may be embodied via network slicing may be defined as a network slice instance.

According to various embodiments of the disclosure, the communication processor 520 may transmit, to the application processor 510, network slice selection assistance information (NSSAI) included in a message (e.g., Registration Accept) received from the core network 430. Based on the NSSAI, the application processor 510 may identify a type of service performed via cellular communication.

According to various embodiments of the disclosure, the NSSAI may include information needed for selecting one of a plurality of network slice instances. Referring to TS 23.501 of 3GPP Release 15, the NSSAI may include slice and service type information (slice/service type (SST)) that is an indicator indicating a type of service, a slice differentiator (SD) used for distinguishing services corresponding to the same service type, and an SD (mapped HPLMN SD) used for distinguishing services of which SST information (mapped HPLMN SST) of a home public land mobile network (HPLMN) provided by the core network 430 is the same as the SST of the HPLMN provided by the core network 430. The slice and service type may be defined as shown in Table 1 below.

TABLE 1

| Type of service | SST value |
|---|---|
| eMBB | 1 |
| URLLC | 2 |
| mMTC | 3 |
| V2X | 4 |

According to various embodiments of the disclosure, the communication processor 520 may identify network slice selection assistance information (NSSAI) included in a message (e.g., an RRC Reconfiguration message or a Registration Accept message including PDU session related information) transmitted to the first node 410 and/or the second node 420, and may identify the type of service performed via cellular communication based on the NSSAI.

According to various embodiments of the disclosure, the application processor 510 may identify a state of the electronic device 101.

According to an embodiment, the state of the electronic device 101 may be a state related to cellular communication used by the electronic device 101. For example, the state of the electronic device 101 may include the throughput of data. As another example, the state of the electronic device 101 may be the feature (e.g., a frequency band, a sub-carrier spacing) of cellular communication used by the electronic device 101. The application processor 510 may receive information related to cellular communication from the communication processor 520 and may identify, based on the received information, the state (e.g., the throughput or subcarrier spacing) of the electronic device 101.

According to an embodiment, the state of the electronic device 101 may be a state related to power of the electronic device 101. For example, the state of the electronic device 101 may be the amount of current consumed (or power consumed) by the electronic device 101 and/or the residual quantity of a battery (e.g., the battery 189 of FIG. 1) of the electronic device 101. Based on information transferred from a temperature sensor (e.g., the sensor module 176 of FIG. 1) and/or a power management module (e.g., the power management module 188 of FIG. 1), the application processor 510 may identify the state information of the electronic device 101.

According to an embodiment, the state of the electronic device 101 may be a state related to a movement of the electronic device 101. For example, the state of the electronic device 101 may include a movement speed of the electronic device 101. Based on information transferred from an acceleration sensor (e.g., the sensor module 176 of FIG. 1), the application processor 510 may identify the state information of the electronic device 101.

According to an embodiment, the state of the electronic device 101 may be a state related to an application activated in the electronic device 101. For example, the state of the electronic device 101 may include information indicating an application (e.g., a background application or a foreground application) activated in the electronic device 101.

According to various embodiments of the disclosure, the application processor 510 may identify a designated condition corresponding to the identified type of service.

According to various embodiments of the disclosure, a designated condition may be a condition used when the electronic device 101 determines whether to perform operations for handover. For example, the designated condition may be a condition for determining whether to perform operations for releasing connection from the first node 410 and connecting to the second node 420 in the state in which the electronic device 101 is connected to the first node 410. As another example, the designated condition may be a condition for maintaining connection to the second node 420 in the state in which the electronic device 101 is connected to the second node 420.

According to various embodiments of the disclosure, the memory 530 may store a plurality of designated conditions. The plurality of designated conditions may be conditions configured differently based on the type of service (e.g., eMBB, URLLC, mMTC, and/or V2X). For example, the memory 530 may store a plurality of designated conditions including a designated condition to be used when the type of service is eMBB, a designated condition to be used when the type of service is URLLC, a designated condition to be used when the type of service is mMTC, and a designated condition to be used when the type of service is V2X.

According to various embodiments of the disclosure, the plurality of designated conditions may be configured to be different according to the type of service allocated. The plurality of designated conditions may be configured by taking into consideration the feature of the type of service allocated. The feature of the type of service may be related to an objective of a predetermined service (e.g., a service (eMBB) that guarantees at least a predetermined speed or a service (URLLC) that guarantees latency less than or equal to a predetermined period of time).

According to various embodiments of the disclosure, the designated condition corresponding to the eMBB service type may be a condition related to the speed of the electronic device 101 and/or the residual quantity of the battery of the electronic device 101.

The condition related to the speed of the electronic device 101 included in the designated condition corresponding to the eMBB service type may be determined in consideration of the amount of power consumed when the electronic device 101 is frequently (e.g., within 5 seconds) handed over according to a movement of the electronic device 101. For example, the condition related to the speed of the electronic device 101 included in the designated condition corresponding to the eMBB service type may be a condition that the speed of the electronic device 101 be less than or equal to 60 km/h.

The condition related to the residual quantity of the battery of the electronic device 101 included in the designated condition corresponding to the eMBB service type may include a condition that the residual quantity of the battery of the electronic device 101 be greater than or equal to a predetermined value (e.g., 20%).

According to various embodiments of the disclosure, the designated condition corresponding to the URLLC service type may be a condition related to the speed of the electronic device 101 and/or the residual quantity of the battery of the electronic device 101.

The condition related to the speed of the electronic device 101 included in the designated condition corresponding to the URLLC service type may be determined in consideration of the amount of power consumed when the electronic device 101 is frequently (e.g., within 10 seconds) handed over according to a movement of the electronic device 101. For example, the condition related to the speed of the electronic device 101 included in the designated condition corresponding to the URLLC service type may be a condition that the speed of the electronic device 101 be less than or equal to 30 km/h.

The condition related to the residual quantity of the battery of the electronic device 101 included in the designated condition corresponding to the URLLC service type may include a condition that the residual quantity of the battery of the electronic device 101 be greater than or equal to a predetermined value (e.g., 40%).

The designated condition corresponding to the eMBB service type and the designated condition corresponding to the URLLC service type may take into consideration the same variables (e.g., the speed of the electronic device 101 or the residual quantity of the battery of the electronic device 101), but detailed conditions (e.g., a value to be compared) may be different from each other. The detailed condition may be configured to be different by taking into consideration the features of the eMBB service and the URLLC service.

According to various embodiments of the disclosure, the designated condition corresponding to the URLLC service type may include a condition related to subcarrier spacing of cellular communication to which the electronic device 101 is to be handed over and is to be connected. For example, the designated condition may include a condition associated with whether the subcarrier spacing of the cellular communication is greater than or equal to a designated value (e.g., 120).

According to various embodiments of the disclosure, the designated condition corresponding to the mMTC service type may be a condition related to the throughput of the electronic device 101 and/or the temperature of the electronic device 101.

The condition related to the throughput of the electronic device 101 included in the designated condition corresponding to the mMTC service type may be determined in consideration of the throughput of data required by a service that the electronic device 101 uses. For example, the condition related to the throughput of the electronic device 101 included in the designated condition corresponding to the mMTC service type may be a condition that the throughput of the electronic device 101 be greater than or equal to 200 Mbps.

The condition related to the temperature of the electronic device 101 included in the designated condition corresponding to the URLLC service type may include a condition that the temperature of the electronic device 101 be greater than or equal to a predetermined value (e.g., 35° C.).

The designated condition corresponding to the mMTC service type and the designated condition corresponding to the URLLC service type or eMBB may be conditions associated with different variables. For example, the designated condition corresponding to the mMTC service type may be a condition associated with the throughput of data and the temperature of the electronic device 101, and the designated condition corresponding to the URLLC service type or the eMBB service type may be a condition related to the speed of the electronic device 101 and the battery of the electronic device 101.

According to various embodiments of the disclosure, a designated condition may be configured to be different depending on the type of service and may be configured in various manners without being limited to the above-mentioned embodiments. For example, a designated condition may be a condition related to whether a designated application is activated in the electronic device 101. The designated application may be an application (e.g., a virtual reality (VR) support application) that requires a relatively high transmission speed.

According to various embodiments of the disclosure, the application processor 510 may identify a designated condition corresponding to the identified type of service from among a plurality of designated conditions stored in the memory 530. The application processor 510 may identify whether the state of the electronic device 101 satisfies a designated condition. Based on whether the state of the electronic deice 101 satisfies the designated condition, the application processor 510 may control the communication processor 520 so that at least one operation that prevents connection to the second node 420 or releases connection from the second node 420 is performed.

According to various embodiments of the disclosure, the application processor 510 may control the communication processor 520 so that at least one operation that prevents connection to the second node 420 or releases connection from the second node 420 is performed in response to identifying that the state of the electronic deice 101 does not satisfy the designated condition.

According to various embodiments of the disclosure, the application processor 510 may control the communication processor 520 so that at least one operation that maintains connection to the second node 420, or releases connection from the first node 410 and connects to the second node 420 is performed in response to identifying that the state of the electronic deice 101 satisfies the designated condition.

According to various embodiments of the disclosure, the application processor 510 may control the communication processor 520 so that at least one operation that prevents connection to the second node 420 is performed in the state in which the electronic device 101 is connected to the first node 410.

According to various embodiments, the application processor 510 may control the communication processor 520 so that the electronic device 101 does not measure the quality (e.g., a signal to noise ratio (SNR), a reference signal received power (RSRP), and/or a reference signal received quality (RSRQ)) of a channel (e.g., a physical uplink control channel (PUCCH) or a physical downlink control channel (PDCCH) of the second node 420) supported by the second node 420, as a part of the at least one operation that prevents connection to the second node 420 in the state in which the electronic device 101 is connected to the first node 410.

According to various embodiments of the disclosure, the application processor 510 may control the communication processor 520 so that the electronic device 101 measures the quality (e.g., a signal to noise ratio (SNR), a reference signal received power (RSRP), and/or a reference signal received quality (RSRQ)) of a channel (e.g., a physical uplink control channel (PUCCH) or a physical downlink control channel (PDCCH) of the second node 420) supported by the second node 420 and does not transmit a quality measurement result to the first node 410, as a part of the at least one operation that prevents connection to the second node 420 in the state in which the electronic device 101 is connected to the first node 410.

According to various embodiments of the disclosure, the application processor 510 may control the communication processor 520 so that the electronic device 101 adjusts a designated value for determining whether to transmit, to the first node 410, a result of measurement of a quality of a channel supported by the second node 420 as a part of the at least one operation that prevents connection to the second node 420 in the state in which the electronic device 101 is connected to the first node 410.

According to various embodiments of the disclosure, by connecting to the electronic device 101, the first node 410 may transmit, to the electronic device 101, information for handover from the first node 410 to the second node 420. For example, the information for handover may include identification information of a new base station (e.g., the second node 420) and a condition (criteria) for reporting a channel quality measurement. The information for handover may be included in an RRC Reconfiguration message that the first node 410 transmits to the electronic device 101.

According to various embodiments of the disclosure, a condition for reporting a channel quality measurement may include a condition that the quality of a channel supported by the second node 420 be greater than or equal to a predetermined value (threshold) or a condition that the quality of a channel supported by the second node 420 be maintained during a predetermined period of time. The communication processor 520 may report a channel quality measurement in response to identifying that the quality of a channel supported by the first node 410 and/or the second node 420 satisfies the condition for reporting a channel quality measurement.

According to various embodiments of the disclosure, the application processor 510 may adjust (or increase) a designated value to be compared with a quality measurement result, so as to decrease the frequency of handover from the first node 410 to the second node 420. The application processor 510 may adjust (or increase) a designated value to be compared with the period of time of maintaining a quality measurement result, so as to decrease the frequency of handover from the first node 410 to the second node 420.

According to various embodiments of the disclosure, the application processor 510 may control the communication processor 520 so that the electronic device 101 performs at least one operation that releases connection from the second node 420 and connects to the first node 410 (that performs handover) in response to identifying that the state of the electronic device 101 does not satisfy the designated condition in the state in which the electronic device 101 is connected to the second node 420.

According to various embodiments of the disclosure, the application processor 510 may control the communication processor 520 so that the electronic device 101 transmits, to the second node 420, a quality measurement result including a value lower than the measured quality of a channel supported by the second node 420 in response to identifying that the state of the electronic device 101 does not satisfy the designated condition in the state in which the electronic device 101 is connected to the second node 420, and thus the connection to the second node 420 may be released.

According to various embodiments of the disclosure, the application processor 510 may transmit, to the second node 420, a quality measurement result including information indicating that connection to the second node 420 is unavailable in response to identifying that the state of the electronic device 101 does not satisfy the designated condition in the state in which the electronic device 101 is connected to the second node 420. The information indicating that connection to the second node 420 is unavailable may be information in which a channel state indicator (channel quality indicator (CQI)) is set to 0.

According to various embodiments of the disclosure, the application processor 510 may control the communication processor 520 so that the electronic device 101 transmits, to the second node 420, a quality measurement result including a value higher than the measured quality of a channel supported by the first node 410 in response to identifying that the state of the electronic device 101 does not satisfy the designated condition in the state in which the electronic device 101 is connected to the second node 420, and thus the connection to the second node 420 may be released. A quality measurement report of a channel supported by the first node 410 may be transmitted via A4 report configuration that may be transmitted in the state in which the strength of a signal of a neighboring node (e.g., the first node 410) is higher than a predetermined value, or may be transmitted via A5 report configuration that may be transmitted in the state in which the strength of a signal of a currently connected node (e.g., the second node 420) is less than a predetermined value and the strength of a signal of a neighboring node (e.g., the first node 410) is greater than a predetermined value.

Through the above-described scheme, in the state in which the electronic device 101 does not need to connect to the second node 420 supporting a second frequency band, the electronic device 101 may prevent unnecessary connection to the second node 420, and thus the power consumption of the electronic device 101 may be decreased.

Although the embodiment described in FIG. 5 has been provided from the perspective in that the application processor 510 controls the communication processor 520, the disclosure is not limited thereto. For example, the communication processor 520 may perform operations of the application processor 510.

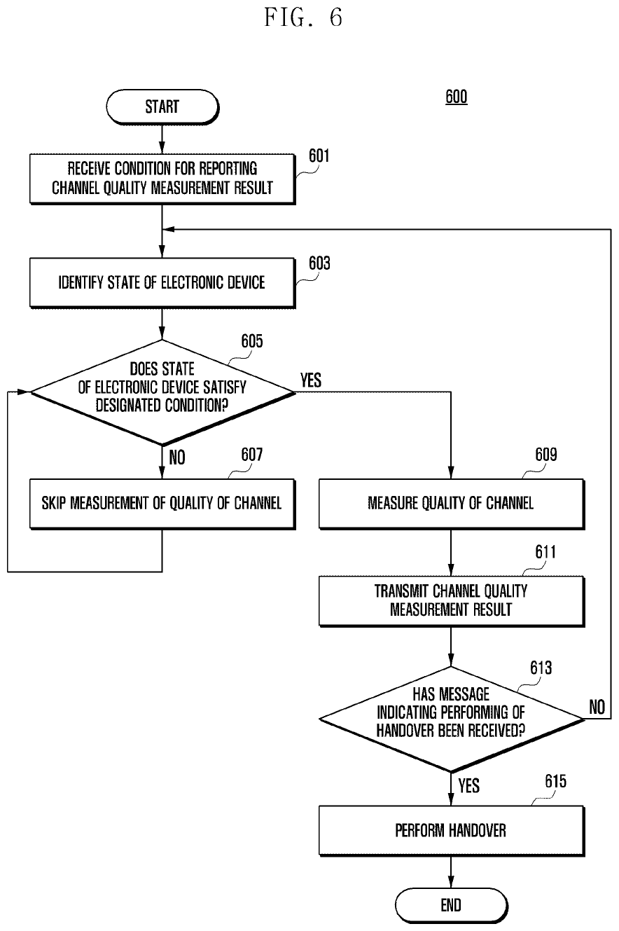

FIG. 6 is a flowchart illustrating operation 600 in which an example electronic device according to various embodiments of the disclosure determines whether to perform handover based on whether the state of the electronic device satisfies a designated condition.

According to various embodiments of the disclosure, in operation 601, an electronic device (e.g., the electronic device 101 of FIG. 1) may receive a condition for reporting a channel quality measurement from the first node 410.

According to various embodiments of the disclosure, by connecting to the electronic device 101, a first node (e.g., the first node 410 of FIG. 4) may transmit, to the electronic device 101, information for handover from the first node 410 to a second node (e.g., the second node 420 of FIG. 4). For example, the information for handover may include identification information of a new base station (e.g., the second node 420) and a condition (criteria) for reporting a channel quality measurement. The information for handover may be included in an RRC Reconfiguration message that the first node 410 transmits to the electronic device 101.

According to various embodiments of the disclosure, a condition for reporting a channel quality measurement may include a condition that the quality of a channel supported by the second node 420 be greater than or equal to a predetermined value (threshold) or a condition that the quality of a channel supported by the second node 420 be maintained during a predetermined period of time. The electronic device 101 may report a channel quality measurement in response to identifying that the quality of a channel supported by the first node 410 and/or the second node 420 satisfies a condition for reporting a channel quality measurement.

According to various embodiments of the disclosure, in operation 603, the electronic device 101 may identify the state of the electronic device 101.

According to an embodiment, the state of the electronic device 101 may include at least one of a state related to cellular communication used by the electronic device 101, a state related to power of the electronic device 101, a state related to a movement of the electronic device 101, or a state related to an activated application in the electronic device 101.

According to various embodiments of the disclosure, in operation 605, the electronic device 101 may determine whether the state of the electronic device 101 satisfies a designated condition.

According to various embodiments of the disclosure, the designated condition may be a condition to be used when the electronic device 101 determines whether to perform operations for handover. For example, the designated condition may be a condition to be used when the electronic device 101 determines whether to perform operations of releasing connection from the first node 410 and connecting to the second node 420 in the state in which the electronic device 101 is connected to the first node 410. As another example, the designated condition may be a condition for maintaining connection to the second node 420 in the state in which the electronic device 101 is connected to the second node 420.

According to various embodiments of the disclosure, the electronic device 101 may identify a designated state corresponding to the identified type of service from among a plurality of designated states. A plurality of designated conditions may be conditions configured differently based on the type of service (e.g., eMBB, URLLC, mMTC, and/or V2X). For example, the plurality of designated conditions may include a designated condition to be used when the type of service is eMBB, a designated condition to be used when the type of service is URLLC, a designated condition to be used when the type of service is mMTC, and a designated condition to be used when the type of service is V2X.

According to various embodiments of the disclosure, the plurality of designated conditions may be configured to be different according to the type of service allocated. The plurality of designated conditions may be configured by taking into consideration the feature of the type of service allocated. The feature of the type of service may be related to an objective of a predetermined service (e.g., a service (eMBB) that guarantees at least a predetermined speed or a service (URLLC) that guarantees latency less than or equal to a predetermined period of time).

According to various embodiments of the disclosure, in operation 607, the electronic device 101 may skip measuring a quality of a channel supported by the second node 420 in response to identifying that the state of the electronic device 101 does not satisfy the designated condition (operation 605-N).

According to various embodiments of the disclosure, the electronic device 101 may skip measuring the quality (e.g., a signal to noise ratio (SNR), a reference signal received power (RSRP), and/or a reference signal received quality (RSRQ)) of a channel (e.g., a physical uplink control channel (PUCCH) or a physical downlink control channel (PDCCH) of the second node 420) supported by the second node 420, as a part of the at least one operation that prevents connection to the second node 420 in the state in which the electronic device 101 is connected to the first node 410.

According to various embodiments of the disclosure, operation 607 may be continued during a predetermined period of time. For example, the electronic device 101 may skip measuring a quality of a channel until a designated time (e.g., 10 seconds) expires based on a timer. After the designated time expires, the electronic device 101 may identify again whether the state of the electronic device 101 satisfies the designated condition.

According to various embodiments of the disclosure, in operation 609, the electronic device 101 may measure a quality of a channel supported by the second node 420 in response to identifying that the state of the electronic device 101 satisfies the designated condition (operation 605-Y).

According to various embodiments of the disclosure, in operation 611, the electronic device 101 may transmit a channel quality measurement result to the first node 410.

According to various embodiments of the disclosure, the electronic device 101 may identify a condition for reporting the quality measurement result received in operation 601, and may transmit the channel quality measurement result in response to identifying that the quality of the channel satisfies the condition for reporting.

According to various embodiments of the disclosure, in operation 613, the electronic device 101 may identify whether a message indicating performing of handover is received from the first node 410.

According to various embodiments of the disclosure, the electronic device 101 may identify the state of the electronic device 101 defined in operation 603 in response to the message indicating performing of handover not being received (operation 613-N).

According to various embodiments of the disclosure, in response to reception of the message indicating performing of handover (operation 613-Y), the electronic device 101 may perform at least one operation for releasing connection from the first node 410 and connecting to the second node 420 in operation 615.

In addition to the case in which the electronic device 101 is handed over from the first node 410 to the second node 420, the disclosure may also be applicable to the case in which the electronic device 101 is additionally connected to the second node 420 in the state in which the electronic device 101 is connected to the first node 410. For example, in a case that the state of the electronic device 101 satisfies the designated condition in the state in which the electronic device 101 is connected to the first node 410, the electronic device 101 may additionally connect to the second node 420.

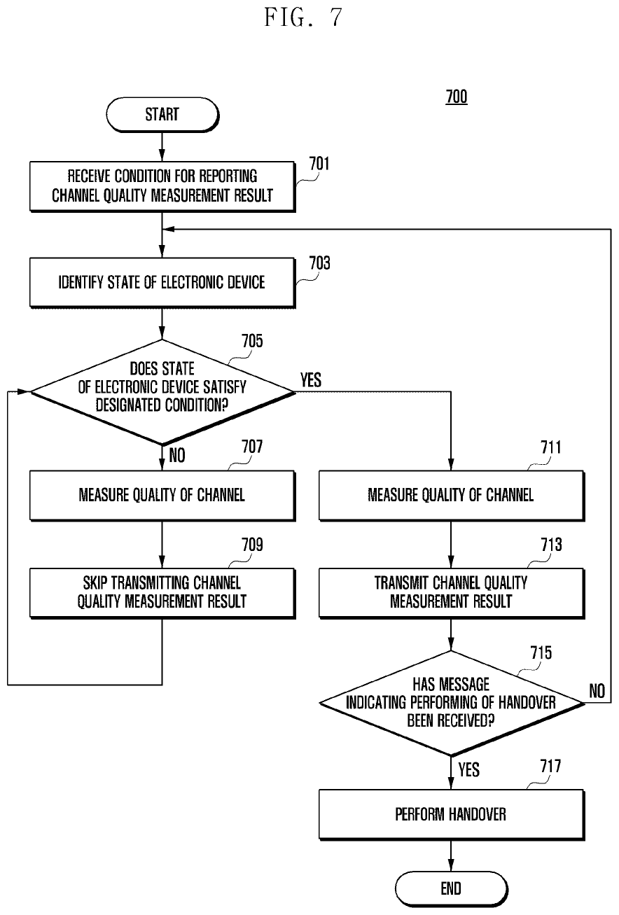

FIG. 7 is a flowchart illustrating operation 700 in which an example electronic device according to various embodiments of the disclosure determines whether to perform handover based on whether the state of the electronic device satisfies a designated condition.

According to various embodiments of the disclosure, in operation 701, an electronic device (e.g., the electronic device 101 of FIG. 1) may receive a condition for reporting a channel quality measurement from the first node 410.

According to various embodiments of the disclosure, by connecting to the electronic device 101, a first node 410 (e.g., the first node 410 of FIG. 4) may transmit, to the electronic device 101, information for handover from the first node 410 to a second node (e.g., the second node 420 of FIG. 4). For example, the information for handover may include identification information of a new base station (e.g., the second node 420) and a condition (criteria) for reporting a channel quality measurement. The information for handover may be included in an RRC Reconfiguration message that the first node 410 transmits to the electronic device 101.

According to various embodiments of the disclosure, a condition for reporting a channel quality measurement may include a condition that the quality of a channel supported by the second node 420 be greater than or equal to a predetermined value (threshold) or a condition that the quality of a channel supported by the second node 420 be maintained during a predetermined period of time. The electronic device 101 may report a channel quality measurement in response to identifying that the quality of a channel supported by the first node 410 and/or the second node 420 satisfies the condition for reporting a channel quality measurement.

According to various embodiments of the disclosure, in operation 703, the electronic device 101 may identify the state of the electronic device 101.

According to an embodiment, the state of the electronic device 101 may include at least one of a state related to cellular communication used by the electronic device 101, a state related to power of the electronic device 101, a state related to a movement of the electronic device 101, or a state related to an activated application in the electronic device 101.

According to various embodiments of the disclosure, in operation 705, the electronic device 101 may determine whether the state of the electronic device 101 satisfies a designated condition.

According to various embodiments of the disclosure, a designated condition may be a condition used when the electronic device 101 determines whether to perform operations for handover. For example, the designated condition may be a condition to be used when the electronic device 101 determines whether to perform operations of releasing connection from the first node 410 and connecting to the second node 420 in the state in which the electronic device 101 is connected to the first node 410. As another example, the designated condition may be a condition for maintaining connection to the second node 420 in the state in which the electronic device 101 is connected to the second node 420.

According to various embodiments of the disclosure, the electronic device 101 may identify a designated state corresponding to the identified type of service from among a plurality of designated states. A plurality of designated conditions may be conditions configured differently based on the type of service (e.g., eMBB, URLLC, mMTC, and/or V2X). For example, the plurality of designated conditions may include a designated condition to be used when the type of service is eMBB, a designated condition to be used when the type of service is URLLC, a designated condition to be used when the type of service is mMTC, and a designated condition to be used when the type of service is V2X.

According to various embodiments of the disclosure, the plurality of designated conditions may be configured to be different according to the type of service allocated. The plurality of designated conditions may be configured by taking into consideration the feature of the type of service allocated. The feature of the type of service may be related to an objective of a predetermined service (e.g., a service (eMBB) that guarantees at least a predetermined speed or a service (URLLC) that guarantees latency less than or equal to a predetermined period of time).

According to various embodiments of the disclosure, in operation 707, the electronic device 101 may measure a quality of a channel supported by the second node 420 in response to identifying that the state of the electronic device 101 does not satisfy the designated condition (operation 705-N).

According to various embodiments of the disclosure, in operation 709, the electronic device 101 may skip transmitting, to the first node 410, a result of measurement of the quality (e.g., a signal to noise ratio (SNR), a reference signal received power (RSRP), and/or a reference signal received quality (RSRQ)) of a channel (e.g., a physical uplink control channel (PUCCH) or a physical downlink control channel (PDCCH) of the second node 420) supported by the second node 420, as a part of the at least one operation that prevents connection to the second node 420 in the state in which the electronic device 101 is connected to the first node 410.

According to various embodiments of the disclosure, operation 709 may be continued during a predetermined period of time. For example, the electronic device 101 may skip transmitting the channel quality measurement result until a designated time (e.g., 10 seconds) expires based on a timer. After the designated time expires, the electronic device 101 may identify again whether the state of the electronic device 101 satisfies the designated condition.

According to various embodiments of the disclosure, in operation 711, the electronic device 101 may measure a quality of a channel supported by the second node 420 in response to identifying that the state of the electronic device 101 satisfies the designated condition (operation 705-Y).

According to various embodiments of the disclosure, in operation 713, the electronic device 101 may transmit the channel quality measurement result to the first node 410.

According to various embodiments of the disclosure, the electronic device 101 identifies a condition for reporting the quality measurement result received in operation 701, and may transmit the channel quality measurement result to the first node 410 in response to identifying that the quality of the channel satisfies the condition for reporting.

According to various embodiments of the disclosure, in operation 715, the electronic device 101 may identify whether a message indicating performing of handover is received from the first node 410.

According to various embodiments of the disclosure, the electronic device 101 may identify the state of the electronic device 101 defined in operation 703 in response to the fact that the message indicating performing of handover is not received (operation 715-N).

According to various embodiments of the disclosure, in operation 717, the electronic device 101 may perform at least one operation for releasing connection from the first node 410 and connecting to the second node 420 in response to reception of the message indicating performing of handover (operation 715-Y).

In addition to the case in which the electronic device 101 is handed over from the first node 410 to the second node 420, the disclosure may also be applicable to the case in which the electronic device 101 is additionally connected to the second node 420 in the state in which the electronic device 101 is connected to the first node 410. For example, in a case that the state of the electronic device 101 satisfies the designated condition in the state in which the electronic device 101 is connected to the first node 410, the electronic device 101 may additionally connect to the second node 420.

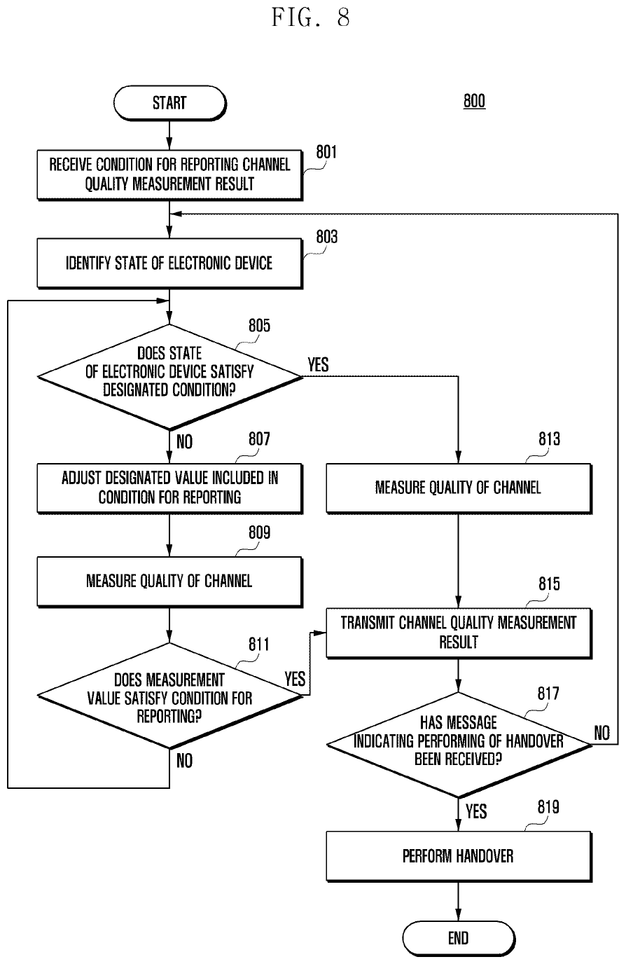

FIG. 8 is a flowchart illustrating operation 800 in which an example electronic device according to various embodiments of the disclosure determines whether to perform handover based on whether the state of the electronic device satisfies a designated condition.

According to various embodiments of the disclosure, in operation 801, an electronic device (e.g., the electronic device 101 of FIG. 1) may receive a condition for reporting a channel quality measurement from the first node 410.

According to various embodiments of the disclosure, by connecting to the electronic device 101, a first node (e.g., the first node 410 of FIG. 4) may transmit, to the electronic device 101, information for handover from the first node 410 to a second node (e.g., the second node 420 of FIG. 4). For example, the information for handover may include identification information of a new base station (e.g., the second node 420) and a condition (criteria) for reporting a channel quality measurement. The information for handover may be included in an RRC Reconfiguration message that the first node 410 transmits to the electronic device 101.

According to various embodiments of the disclosure, a condition for reporting a channel quality measurement may include a condition that the quality of a channel supported by the second node 420 be greater than or equal to a predetermined value (threshold) or a condition that the quality of a channel supported by the second node 420 be maintained during a predetermined period of time. The electronic device 101 may report a channel quality measurement in response to identifying that the quality of a channel supported by the first node 410 and/or the second node 420 satisfies the condition for reporting a channel quality measurement.

According to various embodiments of the disclosure, in operation 803, the electronic device 101 may identify the state of the electronic device 101.

According to an embodiment, the state of the electronic device 101 may include at least one of a state related to cellular communication used by the electronic device 101, a state related to power of the electronic device 101, a state related to a movement of the electronic device 101, or a state related to an activated application in the electronic device 101.

According to various embodiments of the disclosure, in operation 805, the electronic device 101 may determine whether the state of the electronic device 101 satisfies a designated condition.

According to various embodiments of the disclosure, the designated condition may be a condition used when the electronic device 101 determines whether to perform operations for handover. For example, the designated condition may be a condition to be used when the electronic device 101 determines whether to perform operations of releasing connection from the first node 410 and connecting to the second node 420 in the state in which the electronic device 101 is connected to the first node 410. As another example, the designated condition may be a condition for maintaining connection to the second node 420 in the state in which the electronic device 101 is connected to the second node 420.

According to various embodiments of the disclosure, the electronic device 101 may identify a designated state corresponding to the identified type of service from among a plurality of designated states. A plurality of designated conditions may be conditions configured differently based on the type of service (e.g., eMBB, URLLC, mMTC, and/or V2X). For example, the plurality of designated conditions may include a designated condition to be used when the type of service is eMBB, a designated condition to be used when the type of service is URLLC, a designated condition to be used when the type of service is mMTC, and a designated condition to be used when the type of service is V2X.

According to various embodiments of the disclosure, the plurality of designated conditions may be configured to be different according to the type of service allocated. The plurality of designated conditions may be configured by taking into consideration the feature of the type of service allocated. The feature of the type of service may be related to an objective of a predetermined service (e.g., a service (eMBB) that guarantees at least a predetermined speed or a service (URLLC) that guarantees latency less than or equal to a predetermined period of time).

According to various embodiments of the disclosure, in operation 807, the electronic device 101 may adjust a designated value for determining whether to transmit, to the first node 410, a result of measurement of the quality of a channel supported by the second node 420 in response to identifying that the state of the electronic device 101 does not satisfy the designated condition (operation 805-N).

According to various embodiments of the disclosure, a condition for reporting a channel quality measurement may include a condition that the quality of a channel supported by the second node 420 be greater than or equal to a predetermined value (threshold) or a condition that the quality of a channel supported by the second node 420 be maintained during a predetermined period of time.

According to various embodiments of the disclosure, the electronic device 101 may adjust (or increase) a designated value to be compared with the quality measurement result, so as to decrease the frequency of handover from the first node 410 to the second node 420. The electronic device 101 may adjust (or increase) a designated value to be compared with the period of time of maintaining the quality measurement result, so as to decrease the frequency of handover from the first node 410 to the second node 420.

According to various embodiments of the disclosure, in operation 809, the electronic device 101 may measure the quality of a channel supported by the second node 420.

According to various embodiments of the disclosure, in operation 811, the electronic device 101 may identify whether a measured channel value satisfies a condition for reporting a channel quality measurement.

According to various embodiments of the disclosure, in response to identifying that the quality of the channel supported by the first node 410 and/or the second node 420 satisfies a condition for reporting the channel quality measurement (operation 811-Y), the electronic device 101 may report the channel quality measurement in operation 815.

According to various embodiments of the disclosure, in response to identifying that the quality of the channel supported by the first node 410 and/or the second node 420 does not satisfy a condition for reporting the channel quality measurement (operation 811-N), the electronic device 101 may identify whether the state of the electronic device 101 satisfies the designated condition in operation 805.

According to various embodiments of the disclosure, operations 809 and 811 may be continued during a predetermined period of time. For example, until the designated time (e.g., 10 seconds) expires, the electronic device 101 measures, based on a timer, the quality of a channel in operation 809 and identifies whether the measurement value satisfies a condition for reporting in operation 811. After the designated time expires, the electronic device 101 may identify again whether the state of the electronic device 101 satisfies the designated condition.

According to various embodiments of the disclosure, in operation 813, the electronic device 101 may measure a quality of a channel supported by the second node 420 in response to identifying that the state of the electronic device 101 satisfies the designated condition (operation 805-Y).

According to various embodiments of the disclosure, in operation 815, the electronic device 101 may transmit a channel quality measurement result to the first node 410.

According to various embodiments of the disclosure, the electronic device 101 may identify a condition for reporting the quality measurement result received in operation 801, and may transmit the channel quality measurement result to the first node 410 in response to identifying that the quality of the channel satisfies the condition for reporting.

According to various embodiments of the disclosure, in operation 817, the electronic device 101 may identify whether a message indicating performing of handover is received from the first node 410.

According to various embodiments of the disclosure, the electronic device 101 may identify the state of the electronic device 101 stated in operation 803 in response to the fact that the message indicating performing of handover is not received (operation 817-N).

According to various embodiments of the disclosure, in operation 819, the electronic device 101 may perform at least one operation that releases connection from the first node 410 and connects to the second node 420 in response to reception of the message indicating performing of handover (operation 817-Y).

In addition to the case in which the electronic device 101 is handed over from the first node 410 to the second node 420, the disclosure may also be applicable to the case in which the electronic device 101 is additionally connected to the second node 420 in the state in which the electronic device 101 is connected to the first node 410. For example, in a case that the state of the electronic device 101 satisfies the designated condition in the state in which the electronic device 101 is connected to the first node 410, the electronic device 101 may additionally connect to the second node 420.

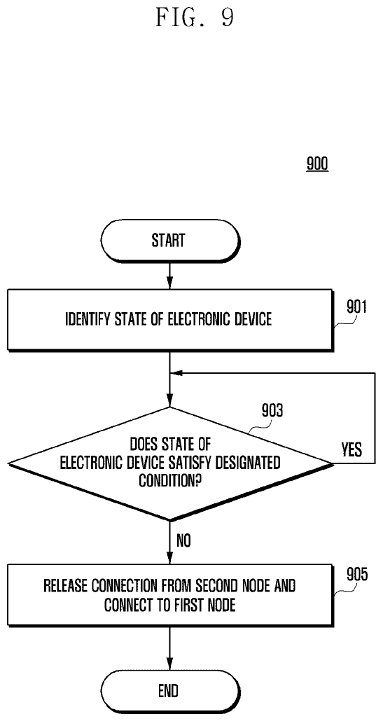

FIG. 9 is a flowchart illustrating an embodiment in which an example electronic device according to various embodiments of the disclosure performs connection to a first node based on whether the state of the electronic device satisfies a designated condition.

According to various embodiments of the disclosure, in operation 901, an electronic device (e.g., the electronic device 101 of FIG. 1) may identify the state of the electronic device 101.

According to an embodiment, the state of the electronic device 101 may include at least one of a state related to cellular communication used by the electronic device 101, a state related to power of the electronic device 101, a state related to a movement of the electronic device 101, or a state related to an activated application in the electronic device 101.

According to various embodiments of the disclosure, a designated condition may be a condition used when the electronic device 101 determines whether to perform operations for handover. For example, the designated condition may be a condition to be used when the electronic device 101 determines whether to perform operations of releasing connection from the first node 410 and connecting to the second node 420 in the state in which the electronic device 101 is connected to the first node 410. As another example, the designated condition may be a condition for maintaining connection to the second node 420 in the state in which the electronic device 101 is connected to the second node 420.

According to various embodiments of the disclosure, the electronic device 101 may identify a designated state corresponding to the identified type of service from among a plurality of designated states. A plurality of designated conditions may be conditions configured differently based on the type of service (e.g., eMBB, URLLC, mMTC, and/or V2X). For example, the plurality of designated conditions may include a designated condition to be used when the type of service is eMBB, a designated condition to be used when the type of service is URLLC, a designated condition to be used when the type of service is mMTC, and a designated condition to be used when the type of service is V2X.

According to various embodiments of the disclosure, the plurality of designated conditions may be configured to be different according to the type of service allocated. The plurality of designated conditions may be configured by taking into consideration the feature of the type of service allocated. The feature of the type of service may be related to an objective of a predetermined service (e.g., a service (eMBB) that guarantees at least a predetermined speed or a service (URLLC) that guarantees latency less than or equal to a predetermined period of time).

According to various embodiments of the disclosure, in operation 903, the electronic device 101 may identify whether the state of the electronic device 101 satisfies a designated condition.

According to various embodiments of the disclosure, in response to identifying that the state of the electronic device 101 satisfies the designated condition (operation 903-Y), the electronic device 101 may maintain connection to the second node 420.

According to various embodiments of the disclosure, in response to identifying that the state of the electronic device 101 does not satisfy the designated condition (operation 903-N), the electronic device 101 may release connection from the second node 420 and may connect to the first node 410 in operation 905.

According to various embodiments of the disclosure, the electronic device 101 may control the communication processor 520 so that the electronic device 101 transmits, to the second node 420, a quality measurement result including a value lower than the measured quality of a channel supported by the second node 420 in response to identifying that the state of the electronic device 101 does not satisfy the designated condition in the state in which the electronic device 101 is connected to the second node 420, and thus the connection to the second node 420 may be released.

According to various embodiments of the disclosure, the electronic device 101 may transmit, to the second node 420, a quality measurement result including information indicating that connection to the second node 420 is unavailable in response to identifying that the state of the electronic device 101 does not satisfy the designated condition in the state in which the electronic device 101 is connected to the second node 420. The information indicating that connection to the second node 420 is unavailable may be information in which a channel state indicator (channel quality indicator (CQI)) is set to 0.

According to various embodiments of the disclosure, the electronic device 101 may control the communication processor 520 so that the electronic device 101 transmits, to the second node 420, a quality measurement result including a value higher than the measured quality of a channel supported by the first node 410 in response to identifying that the state of the electronic device 101 does not satisfy the designated condition in the state in which the electronic device 101 is connected to the second node 420, and thus the connection to the second node 420 may be released. A quality measurement report of a channel supported by the first node 410 may be transmitted via A4 report configuration that may be transmitted in the state in which the strength of a signal of a neighboring node (e.g., the first node 410) is higher than a predetermined value, or may be transmitted via A5 report configuration that may be transmitted in the state in which the strength of a signal of a currently connected node (e.g., the second node 420) is less than a predetermined value and the strength of a signal of a neighboring node (e.g., the first node 410) is greater than a predetermined value.

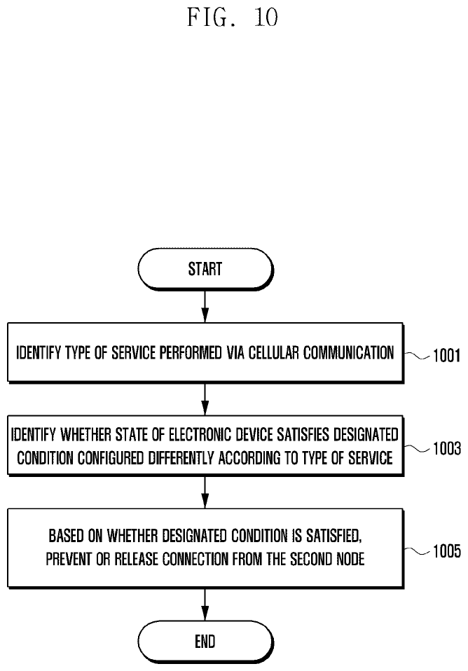

FIG. 10 is a flowchart illustrating an operation method 1000 of an example electronic device according to various embodiments.

According to various embodiments of the disclosure, in operation 1001, the electronic device (e.g., the electronic device 101 of FIG. 1) may identify the type of service performed via cellular communication.

According to various embodiments of the disclosure, based on network slice selection assistance information (NSSAI) included in a message (e.g., a downlink control information (DCI)) received from a core network (e.g., the core network 430 of FIG. 4), the electronic device 101 may identify the type of service performed via cellular communication.

According to various embodiments of the disclosure, in operation 1003, the electronic device 101 may identify whether the state of the electronic device 101 satisfies a designated condition configured differently depending on the type of service.

According to an embodiment, the state of the electronic device 101 may include at least one of a state related to cellular communication used by the electronic device 101, a state related to power of the electronic device 101, a state related to a movement of the electronic device 101, or a state related to an activated application in the electronic device 101.

According to various embodiments of the disclosure, a designated condition may be a condition to be used when the electronic device 101 determines whether to perform operations for handover. For example, the designated condition may be a condition to be used when the electronic device 101 determines whether to perform operations of releasing connection from the first node 410 and connecting to the second node 420 in the state in which the electronic device 101 is connected to the first node 410. As another example, the designated condition may be a condition for maintaining connection to the second node 420 in the state in which the electronic device 101 is connected to the second node 420.

According to various embodiments of the disclosure, the electronic device 101 may identify a designated state corresponding to the identified type of service from among a plurality of designated states. The plurality of designated conditions may be conditions configured differently based on the type of service (e.g., eMBB, URLLC, mMTC, and/or V2X). For example, the plurality of designated conditions may include a designated condition to be used when the type of service is eMBB, a designated condition to be used when the type of service is URLLC, a designated condition to be used when the type of service is mMTC, and a designated condition to be used when the type of service is V2X.

According to various embodiments of the disclosure, the plurality of designated conditions may be configured to be different according to the type of service allocated. The plurality of designated conditions may be configured by taking into consideration the feature of the type of service allocated. The feature of the type of service may be related to an objective of a predetermined service (e.g., a service (eMBB) that guarantees at least a predetermined speed or a service (URLLC) that guarantees latency less than or equal to a predetermined period of time).

According to various embodiments of the disclosure, in operation 1005, based on whether the designated condition is satisfied, the electronic device 101 may prevent connection to the second node 420 or may release connection from the second node 420.

According to various embodiments of the disclosure, the electronic device 101 may control the communication processor 520 so that the electronic device 101 performs at least one operation that prevents connection to the second node 420 in the state in which the electronic device 101 is connected to the first node 410.

According to various embodiments of the disclosure, the electronic device 101 may control the communication processor 520 so that the electronic device 101 does not measure the quality (e.g., a signal to noise ratio (SNR), a reference signal received power (RSRP), and/or a reference signal received quality (RSRQ)) of a channel (e.g., a physical uplink control channel (PUCCH) or a physical downlink control channel (PDCCH) of the second node 420) supported by the second node 420, as a part of the at least one operation that prevents connection to the second node 420 in the state in which the electronic device 101 is connected to the first node 410.

According to various embodiments of the disclosure, the electronic device 101 may control the communication processor 520 so that the electronic device 101 measures the quality (e.g., a signal to noise ratio (SNR), a reference signal received power (RSRP), and/or a reference signal received quality (RSRQ)) of a channel (e.g., a physical uplink control channel (PUCCH) or a physical downlink control channel (PDCCH) of the second node 420) supported by the second node 420 and does not transmit a quality measurement result to the first node 410, as a part of the at least one operation that prevents connection to the second node 420 in the state in which the electronic device 101 is connected to the first node 410.

According to various embodiments of the disclosure, the electronic device 101 may control the communication processor 520 so that the electronic device 101 adjusts a designated value for determining whether to transmit, to the first node 410, a result of measurement of the quality of a channel supported by the second node 420 as a part of the at least one operation that prevents connection to the second node 420 in the state in which the electronic device 101 is connected to the first node 410.

According to various embodiments of the disclosure, by connecting to the electronic device 101, the first node 410 may transmit, to the electronic device 101, information for handover from the first node 410 to the second node 420. For example, the information for handover may include identification information of a new base station (e.g., the second node 420) and a condition (criteria) for reporting a channel quality measurement. The information for handover may be included in an RRC Reconfiguration message that the first node 410 transmits to the electronic device 101.

According to various embodiments of the disclosure, a condition for reporting a channel quality measurement may include a condition that the quality of a channel supported by the second node 420 be greater than or equal to a designated value (threshold) or a condition that the quality of a channel supported by the second node 420 be maintained during a predetermined period of time. The communication processor 520 may report a channel quality measurement in response to identifying that the quality of a channel supported by the first node 410 and/or the second node 420 satisfies the condition for reporting a channel quality measurement.

According to various embodiments of the disclosure, the electronic device 101 may adjust (e.g., increase) a designated value to be compared with the quality measurement result, so as to decrease the frequency of handover from the first node 410 to the second node 420. The electronic device 101 may adjust (e.g., increase) a designated value to be compared with the period of time of maintaining the quality measurement result, so as to decrease the frequency of handover from the first node 410 to the second node 420.

According to various embodiments of the disclosure, the electronic device 101 may control the communication processor 520 so that the electronic device 101 performs at least one operation that releases connection from the second node 420 and connects to the first node 410 (that performs handover) in response to identifying that the state of the electronic device 101 does not satisfy the designated condition in the state in which the electronic device 101 is connected to the second node 420.

According to various embodiments of the disclosure, the electronic device 101 may control the communication processor 520 so that the electronic device 101 transmits, to the second node 420, a quality measurement result including a value lower than the measured quality of a channel supported by the second node 420 in response to identifying that the state of the electronic device 101 does not satisfy the designated condition in the state in which the electronic device 101 is connected to the second node 420, and thus the connection to the second node 420 may be released.

According to various embodiments of the disclosure, the electronic device 101 may transmit, to the second node 420, a quality measurement result including information indicating that connection to the second node 420 is unavailable in response to identifying that the state of the electronic device 101 does not satisfy the designated condition in the state in which the electronic device 101 is connected to the second node 420. The information indicating that connection to the second node 420 is unavailable may be information in which a channel state indicator (channel quality indicator (CQI)) is set to 0.

According to various embodiments of the disclosure, the electronic device 101 may control the communication processor 520 so that the electronic device 101 transmits, to the second node 420, a quality measurement result including a value higher than the measured quality of a channel supported by the first node 410 in response to identifying that the state of the electronic device 101 does not satisfy the designated condition in the state in which the electronic device 101 is connected to the second node 420, and thus the connection to the second node 420 may be released. In this instance, the measured quality of a channel supported by the first node 410 may be a value higher than a designated value (A2 threshold) that the second node 420 transmits. A quality measurement report of a channel supported by the first node 410 may be transmitted via A4 report configuration that may be transmitted in the state in which the strength of a signal of a neighboring node (e.g., the first node 410) is higher than a predetermined value, or may be transmitted via A5 report configuration that may be transmitted in the state in which the strength of a signal of a currently connected node (e.g., the second node 420) is less than a predetermined value and the strength of a signal of a neighboring node (e.g., the first node 410) is greater than a predetermined value.

According to the above-described method, in a case that the electronic device 101 may not need to connect to the second node 420 supporting a second frequency band, the electronic device 101 may prevent unnecessary connection to the second node 420, and thus the power consumption of the electronic device 101 may be decreased.

An electronic device according to various embodiments of the disclosure may include a communication processor configured to perform cellular communication with a first node supporting a first frequency band or a second node supporting a second frequency band, an application processor, and a memory, and the memory may store instructions which, when executed, cause the electronic device to identify a type of service performed via the cellular communication, identify whether a state of the electronic device satisfies a designated condition configured differently based on the type of service, and, in response to identifying that the state of the electronic device does not satisfy the designated condition, perform at least one operation that prevents connection to the second node or releases connection from the second node.

In an electronic device according to various embodiments of the disclosure, the memory may store a plurality of designated conditions, and the memory may store instructions which, when executed, cause the electronic device to identify a designated condition corresponding to the identified type of service from among the plurality of designated conditions, and identify whether the state of the electronic device satisfies a designated condition.

In an electronic device according to various embodiments of the disclosure, the designated condition may include a condition related to a residual quantity of a battery of the electronic device, a condition related to an amount (throughput) of traffic of data transmitted or received per unit time, or a condition related to a subcarrier spacing (SCS) of the second frequency band.

In an electronic device according to various embodiments of the disclosure, the memory may further store instructions which, when executed, cause the electronic device not to measure the quality of a channel supported by the second node as a part of an operation of preventing connection to the second node in a state in which the electronic device is connected to the first node.

In an electronic device according to various embodiments of the disclosure, the memory may further store instructions which, when executed, cause the electronic device not to transmit, to the first node, a result of measurement of the quality of a channel supported by the second node as a part of an operation of preventing connection to the second node in a state in which the electronic device is connected to the first node.

In an electronic device according to various embodiments of the disclosure, the memory may further store instructions which, when executed, cause the electronic device to adjust a designated value to determine whether to transmit, to the first node, a result of measurement of the quality of a channel supported by the second node as a part of an operation of preventing connection to the second node in a state in which the electronic device is connected to the first node.

In an electronic device according to various embodiments of the disclosure, the designated value may be at least one of a designated value to be compared with the quality measurement result or a value related to a duration of maintaining the quality.

In an electronic device according to various embodiments of the disclosure, the memory may further store an instruction which, when executed, causes the electronic device to connect to the second node in response to identifying that the state of the electronic device satisfies a designated condition in a state in which the electronic device is connected to the first node.

In an electronic device according to various embodiments of the disclosure, the memory may further store an instruction which, when executed, controls the electronic device to transmit, to the second node, a quality measurement result including a lower value than a measured quality value of a channel supported by the second node as a part of an operation of releasing connection from the second node in a state in which the electronic device is connected to the second node.

In an electronic device according to various embodiments of the disclosure, the memory may further store an instruction which, when executed, controls the electronic device to transmit, to the second node, a quality measurement result including a higher value than a measured quality value of a channel supported by the first node as a part of an operation of releasing connection from the second node in a state in which the electronic device is connected to the second node.

In an electronic device according to various embodiments of the disclosure, the memory may further store an instruction which, when executed, controls the electronic device to transmit, to the second node, a quality measurement result including information indicating that connection to the second node is unavailable as a part of an operation of releasing connection from the second node in a state in which the electronic device is connected to the second node.

An operation method of an electronic device according to various embodiments of the disclosure may include an operation of identifying a type of service performed via the cellular communication, identifying whether a state of the electronic device satisfies a designated condition configured differently based on the type of service, and performing at least one operation of preventing connection to the second node or releasing connection from the second node based on whether the state of the electronic device satisfies the designated condition.

An operation method of an electronic device according to various embodiments of the disclosure may further include an operation of identifying a designated condition corresponding to the identified type of service from among a plurality of designated conditions stored in a memory, and an operation of identifying whether the state of the electronic device satisfies the designated condition.

In an operation method of an electronic device according to various embodiments of the disclosure, the designated condition may include a condition related to a residual quantity of a battery of the electronic device, a condition related to an amount (throughput) of traffic of data transmitted or received per unit time, or a condition related to a subcarrier spacing (SCS) of the second frequency band.

In an operation method of an electronic device according to various embodiments of the disclosure, the operation of preventing the connection to the second node may include an operation of preventing measurement of the quality of a channel supported by the second node.

In an operation method of an electronic device according to various embodiments of the disclosure, the operation of preventing the connection to the second node may include an operation of preventing transmitting, to the first node, a result of measurement of the quality of a channel supported by the second node.

In an operation method of an electronic device according to various embodiments of the disclosure, the operation of preventing the connection to the second node may include an operation of adjusting a designated value for determining whether to transmit, to the first node, a result of measurement of the quality of a channel supported by the second node.

In an operation method of an electronic device according to various embodiments of the disclosure, the designated value may be at least one of a designated value to be compared with the quality measurement result or a value related to a duration of maintaining the quality.

In an operation method of an electronic device according to various embodiments of the disclosure, the operation of releasing the connection from the second node may include an operation of transmitting, to the second node, a quality measurement result including a value lower than the measured quality value of a channel supported by the second node.

In an operation method of an electronic device according to various embodiments of the disclosure, the operation of releasing the connection from the second node may include an operation of transmitting, to the second node, a quality measurement result including a value higher than the measured quality value of a channel supported by the first node.

In an operation method of an electronic device according to various embodiments of the disclosure, the operation of releasing the connection from the second node may include an operation of transmitting, to the second node, a quality measurement result including information indicating that connection to the second node is unavailable.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular example embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and do not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium, where the term “non-transitory” simply refers to the storage medium being a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those of ordinary skill in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a communication processor configured to perform cellular communication with a first node supporting a first frequency band or a second node supporting a second frequency band;
an application processor; and
a memory,
wherein the memory stores instructions which, when executed, cause the electronic device to:
identify a type of service performed via the cellular communication performed by the communication processor;
identify whether a state of the electronic device satisfies a designated condition configured differently based on the type of service; and
in response to identifying that the state of the electronic device does not satisfy the designated condition, perform at least one operation that prevents connection by the communication processor to the second node or releases connection by the communication processor from the second node.

2. The electronic device of claim 1, wherein the memory stores a plurality of designated conditions, and
wherein the memory stores instructions which, when executed, cause the electronic device to:
identify a designated condition corresponding to the identified type of service from among the plurality of designated conditions; and
identify whether the state of the electronic device satisfies a designated condition.

3. The electronic device of claim 1, wherein the designated condition comprises a condition related to a residual quantity of a battery of the electronic device, a condition related to an amount of traffic of data transmitted or received per unit time, or a condition related to a subcarrier spacing (SCS) of the second frequency band.

4. The electronic device of claim 1, wherein the memory further stores instructions which, when executed, cause the electronic device not to measure a quality of a channel supported by the second node as a part of an operation of preventing connection to the second node in a state in which the electronic device is connected to the first node.

5. The electronic device of claim 1, wherein the memory further stores instructions which, when executed, cause the electronic device not to transmit, to the first node, a result of measurement of a quality of a channel supported by the second node as a part of an operation of preventing connection to the second node in a state in which the electronic device is connected to the first node.

6. The electronic device of claim 1, wherein the memory further stores instructions which, when executed, cause the electronic device to adjust a designated value to determine whether to transmit, to the first node, a result of measurement of a quality of a channel supported by the second node as a part of an operation of preventing connection to the second node in a state in which the electronic device is connected to the first node.

7. The electronic device of claim 6, wherein the designated value is at least one of a designated value to be compared with the quality measurement result or a value related to a duration of maintaining the quality.

8. The electronic device of claim 1, wherein the memory further stores an instruction which, when executed, causes the electronic device to connect to the second node in response to identifying that the state of the electronic device satisfies a designated condition in a state in which the electronic device is connected to the first node.

9. The electronic device of claim 1, wherein the memory further stores an instruction which, when executed, controls the electronic device to transmi, to the second node, a quality measurement result including a lower value than a measured quality value of a channel supported by the second node as a part of an operation of releasing connection from the second node in a state in which the electronic device is connected to the second node.

10. The electronic device of claim 1, wherein the memory further stores an instruction which, when executed, controls the electronic device to transmit, to the second node, a quality measurement result including a higher value than a measured quality value of a channel supported by the first node as a part of an operation of releasing connection from the second node in a state in which the electronic device is connected to the second node.

11. The electronic device of claim 1, wherein the memory further stores an instruction which, when executed, controls the electronic device to transmit, to the second node, a quality measurement result including information indicating that connection to the second node is unavailable as a part of an operation of releasing connection from the second node in a state in which the electronic device is connected to the second node.

12. An operation method of an electronic device, the method comprising:
identifying a type of service performed via cellular communication;
identifying whether a state of the electronic device satisfies a designated condition configured differently based on the type of service; and
based on whether the state of the electronic device satisfies the designated condition, performing at least one operation of preventing connection to the second node or releasing connection from the second node.

13. The method of claim 12, further comprising:
identifying a designated condition corresponding to the identified type of service from among a plurality of designated conditions stored in a memory; and
identifying whether the state of the electronic device satisfies the designated condition.

14. The method of claim 12, wherein the designated condition comprises a condition related to a residual quantity of a battery of the electronic device, a condition related to an amount of traffic of data transmitted or received per unit time, or a condition related to a subcarrier spacing (SCS) of the second frequency band.

15. The method of claim 12, wherein the preventing of the connection to the second node comprises preventing measurement of a quality of a channel supported by the second node.
